(19) United States
(12) Patent Application Publication
(10) Pub. No.: US 2015/0029024 A1
(43) Pub. Date: Jan. 29, 2015

(54) System and Method for Locating Missing Airline Baggage

(71) Applicants: Chris Outwater, Santa Barbara, CA (US); William Gibbens Redmann, Glendale, CA (US)

(72) Inventors: Chris Outwater, Santa Barbara, CA (US); William Gibbens Redmann, Glendale, CA (US)

(21) Appl. No.: 13/949,440

(22) Filed: Jul. 24, 2013

(51) Int. Cl. G08B 21/18

(52) U.S. Cl. CPC G08B 21/18
USPC 340/539.13

(57) ABSTRACT

A customer subscribes to a bag track service and gives his identity and cellphone number. The customer is supplied with an RF enabled electronic tag which is placed in a piece of baggage. Once the bag is checked in, the customer scans the bag strip with his cellphone. If a particular bag doesn't arrive at a destination, the subscriber notifies the service of the missing bag by again scanning or photographing the bag stub, or by entering the tag ID. The missing tag information is sent to all registered search applications carried by members of the public, baggage handlers, and/or to all installed airport piconets. Each phone with such an application will then actively try to pair with the unique ID tag in the missing bag. If any such application successfully pairs with the tag, the phone sends this information back to the tracking service.

### BACKGROUND

1. Field of the Invention

The present invention relates generally to airline baggage tracking and more particularly to a system and method for locating missing airline baggage.

2. Description of the Prior Art

Modern airline travel is for the most part convenient and comfortable. However, unfortunately, checked bags sometimes fail to show up at a destination location when the passenger goes to pick them up.

Airlines typically tag bags with a paper strip containing a barcode with a bag tracking number and the flight number. The paper strip is wrapped around a bag handle and clearly shows the airport destination location and flight number. The passenger is given a stub from this strip showing the tracking number both visually and coded in an identical barcode as on the bag strip. In the case of connecting flights, a bag may receive more than one strip.

Since bags are generally handled by human baggage handlers, it is entirely possible for an occasional bag to be put on the wrong flight. Only after a bag is not claimed at a wrong destination airport does an airline worker scan the barcode and try to determine why the bag was not picked up. This may not occur for as much as a half hour or even an hour after the misplaced bag shows up at the wrong airport. Finally, the airline worker, after determining that the airport is wrong, makes an entry into the airline's bag tracking database, and schedules the bag on the next flight to the correct destination airport. Until the entry is made in the airline system, it is impossible for anyone to determine where the bag is and when it might arrive. Many hours (and even several days sometimes) may pass before the passenger knows that the bag has been found and when they might expect it.

It would be particularly advantageous to have a system and method of finding a lost bag more rapidly and reporting where it is to the bag owner.

When a number of people are searching for a lost item simultaneously, the time to find it decreases very rapidly. It would be advantageous to have a way the many different people and different locations could electronically (and without effort) search for a missing bag.

Airline baggage is not worth much to thieves, and hence, bags are not stolen often. However, a bag that fails to arrive at a destination on time can be a major problem to a baggage, especially if the bag contains materials needed for the trip (such as presentation materials or the like) or clothing destined to be worn at the destination location (such as a suit). Many customers would be willing to belong to a service that could provide a level of comfort by having a method that can locate lost bags in airports throughout the system very quickly. It would be advantageous to have such a service that customers could subscribe to that would track and find airline baggage.

### SUMMARY OF THE INVENTION

The present invention relates to a system and method of tracking baggage and finding lost bags. While it is primarily directed toward airline travel, it works equally well with other travel modes such as boat, train, bus and others.

According to the present invention, a customer subscribes to a bag track service. He gives information about himself such as his identity and cellphone number. The customer purchases or is otherwise supplied with one or more Bluetooth® or other RF enabled electronic tags (Bluetooth® is a registered trademark of Bluetooth SIG, Inc., of Kirkland, Wash.). Each tag contains an ID that is uniquely tied to that particular customer. Before the trip, the customer can notify the service that he or she is traveling, the date, flight and the electronic tag numbers that will be used. The customer then places one of these tags inside each piece of baggage before checking it. Before closing the bag, the tag is turned on with a switch. Once the tag is turned on, it can pair up with the customer's cellphone's Bluetooth® transceiver as is known in the art or with another RF system. The cellphone can then upload the electronic tag ID from the tag. The customer can also optionally photograph the bag.

Once the bag is checked in, the customer scans the airline bag strip (called in the industry a “license plate”) or the stub with his cellphone, or alternatively photographs it. This makes a record of the airline baggage source message (BSM) on the particular bag strip. BSMs are used by all major airlines. At this point, the cellphone transfers all of this information to the tracking service.

The tracking service can provide piconets at numerous airport baggage handling areas and can encourage baggage handlers and the general public to load a special bag search application into their phones. If a particular bag doesn't arrive at a destination on time, the subscriber notifies the service of the missing bag by again scanning or photographing the bag stub, or by entering the tag ID. or resending the license plate.

According to the present invention, the missing tag information can be sent to all registered search applications carried by members of the public, baggage handlers, and/or to all installed airport piconets. Each phone with such an application will then actively try to pair with the unique ID tag in the missing bag. If any such application successfully pairs with the tag (meaning that the missing bag is within about 30 feet of the phone), the phone sends this information back to the tracking service. The phone can alternatively beep notifying a baggage handler of a missing bag. Bags can optionally have a visual marking like a large yellow tag so that after pairing, the bag can be visually located and identified as being part of the service. Members of the general public could be enticed to carry these applications by knowing they are helping each other and possibly receiving a reward when their phone finds and reports a missing bag. Once a missing bag is located, all of the searching applications can be deactivated for that particular tag ID.

### DESCRIPTION OF THE FIGURES

Attention is directed to several drawings that illustrate features of the present invention:

FIG. 1 is an example block diagram for a system to locate missing bags using wireless tags.

FIG. 2 is an example block diagram for a tag, in this example implemented using Bluetooth® technology.

FIG. 3 is an example schema for a portion of a database for associating bags with tags and for handling searches when such bags go missing.

FIG. 4 is an example schema for a portion of a database extending that shown in FIG. 3, which tracks information to make searches more efficient, and to provide missing bag reports suitable for submitting to airlines.

FIG. 5 is a flowchart for a bag proximity check process, to see whether a particular bag is nearby.

FIG. 6 is a flowchart for a search process, to attempt to locate a particular bag.

Several drawings and illustrations have been presented to aid in understanding the present invention. The scope of the present invention is not limited to what is shown in the figures.

### DESCRIPTION OF THE PREFERRED EMBODIMENT

The present invention relates to a system and method of tracking baggage and finding lost bags. According to the present invention, a customer subscribes to a baggage tracking service and registers his name, address, cell phone and possibly other information. The customer can notify the service via a phone call or online access that he is traveling from airport A to B on X airline on Y date, i.e., his itinerary, or in a preferred embodiment, the customer notifies the service and initializes bag tracking by scanning or photographing the bag license plate that he gets at baggage check-in with his wireless device, such as a smartphone. He then sends that image, or images if multiple bags, via his phone's wireless network to the service's secure, central database service so that the service has an active record of his airline bag tag. The license plate contains the encrypted baggage source message BSM used by all major airlines. The BSM is used by the airlines to route the bag. Thus, the subscribed customer's personal ID information and bag license plate and BT tag and itinerary and perhaps entire bag photograph are all correlated in the service's database during active tracking. The tracking process initializes on the service site when the customer sends the images of his airline license plate tags, preferably, before he departs on his first flight.

As previously stated, the customer purchases from the service or is otherwise supplied with one or more Bluetooth® enabled electronic tags. While Bluetooth® is the preferred RF method, any RF communications technique may be used. These tags may be supplied in bulk, or they may be purchased for a particular trip. Each tag contains an ID that is uniquely tied to that particular customer. The customer places one of these tags inside each piece of baggage before checking it (another can be optionally attached to the outside of the bag). Before closing the bag, the tag is turned on with a switch or otherwise turned on. Once the tag is active, it can pair up with A cellphone's Bluetooth® transceiver as is known in the art (or other RF system). The cellphone can then upload the electronic tag ID from the tag and send it to the service. If a single tag or set of tags was purchased for one trip only, the service may already have this information.

The customer can call in and ask for help, if his baggage does not arrive as planned. Or, in some embodiments, the service can notify him upon arrival at the airport that his bag(s) did or did not make the flight. Informing customers even before they go to baggage claim whether their bags made it or not can be a very valuable time-saver.

The service or the airline/airport can install stationary Bluetooth® piconets with MASTERS and SLAVES in the airport baggage processing and claim areas around the globe. The SLAVES in the piconet could be paging the electronic tags as the bags pass through the piconet active areas. The MASTERS of the piconets can be tied to a wireless communication gateway that reports all tracking activity to our central database.

In addition, according to the present invention, the service can diligently enlist baggage claim departments at major airports around the world. The baggage handling employees can be encouraged to run a special search smartphone application on their phones. Thus, their phones can also act as MASTERS in paging the tracked or lost baggage. When a customer calls in and indicates his bag(s) did not arrive, then our service will already know his itinerary and the status of his baggage. In particular embodiments of the invention, the employees may only be asked to page misplaced or lost baggage, not to also track baggage that is on schedule.

In the case of missing baggage, the service can publish the registered, unique ID and address for the Bluetooth® tags to all of the baggage employees at all of the pertinent airport baggage claim areas for that airline. This process can be based on the itinerary that was reported from the barcode and bag tag the customer scanned or photographed with his wireless device. However, since there may be no way of knowing exactly where a missing bag went, an all-stations alert can be issued, or a targeted alert to all possible destinations computed from the departure airport within the relevant time frame. The bag may still be in the departure airport, so this location should usually always receive the alert. In any case, once an alert is issued for a particular bag, the stationary piconet and a team of people who are on the job in the target baggage areas and fellow customers subscribed to the service will begin paging the missing bag(s).

Any employee or searcher actively paging the SLAVE baggage can hear a beep on his phone if he/she is within 30 feet of the baggage. The employee will also have a copy of the code in the phone that is tied to that Bluetooth® address, and if they have a barcode reader on their phone, they can match the bag to the target search bag. They can then send a message with their location and thus the location of the target bag. The bag can then be placed back into the system.

The baggage will have the electronic tag inside (so the tag cannot be stolen), and in addition to the airline's license plate baggage tag, the baggage can also have a brightly colored, tag (such as a big yellow tag) on the handle or side that signifies it is a piece of baggage registered with the tracking service program of the present invention. If a baggage claim person is walking around and gets an alert, and then senses A vibration or hears a beep on his/her phone then they will know someone is looking for a bag that is within 30 feet of them at that moment.

In some embodiments of the invention, the beep gets faster the closer the employee gets to the target bag. Also, the searcher is directed to look for a bag with a big visible, brightly colored tag indicative of the service of the present invention. The searcher or employee matches the two and can scan the bar code and get the bag back into the system, as well as reporting the find to the service. Although, in one embodiment, the telephone application can do this seamlessly without involving a searcher. The service of the invention can tie in with frequent flier rewards, first class upgrades, priority baggage treatment and transfer. The service's customer's bags can come out first. The customer is enlisting the third party service of the present invention to help him feel more secure when handing his baggage to the airlines.

As previously stated, In another embodiment, the service can enlist a group of trusted customers and airline employees to help find misplaced baggage. The vast majority of customers do not pack anything of great value in their check in baggage. In fact, trusted members of the general public with smartphones can also have search applications and hence act as part of the network. These members may be other subscribers to the service, or they could be anyone with a phone capable of running the search application. This technique can be called crowd-searching. Rewards could be offered to anyone using the application who finds a missing bag. However, if anyone is allowed to search for rewards, security measures must be in place to keep untrustworthy people from stealing or misplacing a marked bag and then later “finding” it to claim the reward. One way is to limit the number of rewards a particular individual can earn and how often they can earn them.

The present invention automatically ties the airline baggage tag/barcode to the customer, his cell phone number and his personal registration and the unique Bluetooth® address(es) for his bag(s). The customer can scan the bag tag barcode from the paper copies the airline gives him at his leisure, perhaps after he goes through security and while he is waiting for his flight rather then having to scan them at the instant the bag is handed over. If there is a series of connecting flights to a destination, the service can follow the progress of the bag(s) and make continual reports. In this embodiment, (that may represent a more active and more expensive service level), the service might know before the customer goes to the baggage claim that one or more bags did not make the flight. While this can be bad news for the customer, there is no waiting in line for hours to see if the missing bag will come in and then waiting to fill out the forms. The service can handle the process with the airline. In one embodiment, the service would only notify the customer if his bags did not make a flight. In another embodiment, the service could wait for a call or message from the customer and then start the search if a customer's bag does not show upon arrival.

If one of the customer's bags comes in, but the others do not, then the customer can choose the one(s) that did not show up from the drop down list of all of his bags on the applications screen on his smartphone. The service then helps him find the missing bag with the Bluetooth® enabled team. The other bags can drop off the active list after a specified time (such as one or two days), as it will be determined that there was no problem with that baggage.

When a customer registers for the service and lists his cellphone and name, etc., the service can recognize the cellphone number using caller ID (and perhaps a pin can be requested), so the service recognizes the customer who is calling or texting the service's number. The service then knows to begin to page for his baggage that did not show up. The customer can tap the bag(s) that did not show up on his drop down list and then move on with his day knowing the service will do everything possible to find his bag(s). Also, the customer can be asked where he would like his bag(s) sent, if he decides not to wait for them. If flights are canceled or connections missed, the service can help the customer find out where his bag(s) are.

In summary, the present invention includes the following:
1) The customer subscribes to the bag track service. He gives information about himself and his identity, such as his cell phone and address.
2) The customer purchases special Bluetooth® enabled electronic tags from the service. These tags are tied to his subscription and his ID data. He affixes a single electronic tag inside each of his bags. He can optionally also attach an external, UNIQUE tag to the bag's handle. This tag can show the customer's name, address, and also have a barcode the ties the name and ID to a list of Bluetooth® tags delivered to the customer.
3) The customer turns on the tag with a switch or button before traveling. The tag can automatically turn off after a predetermined period of time.
4) Upon baggage check in, the customer scans the airline's license plate bag tag for each bag and sends this image(s) to us, preferably before his first flight.
5) If a bag fails to show up, the customer can call the service for help in finding it (or the service can continually track all of the customer's bags and report to him where they are).

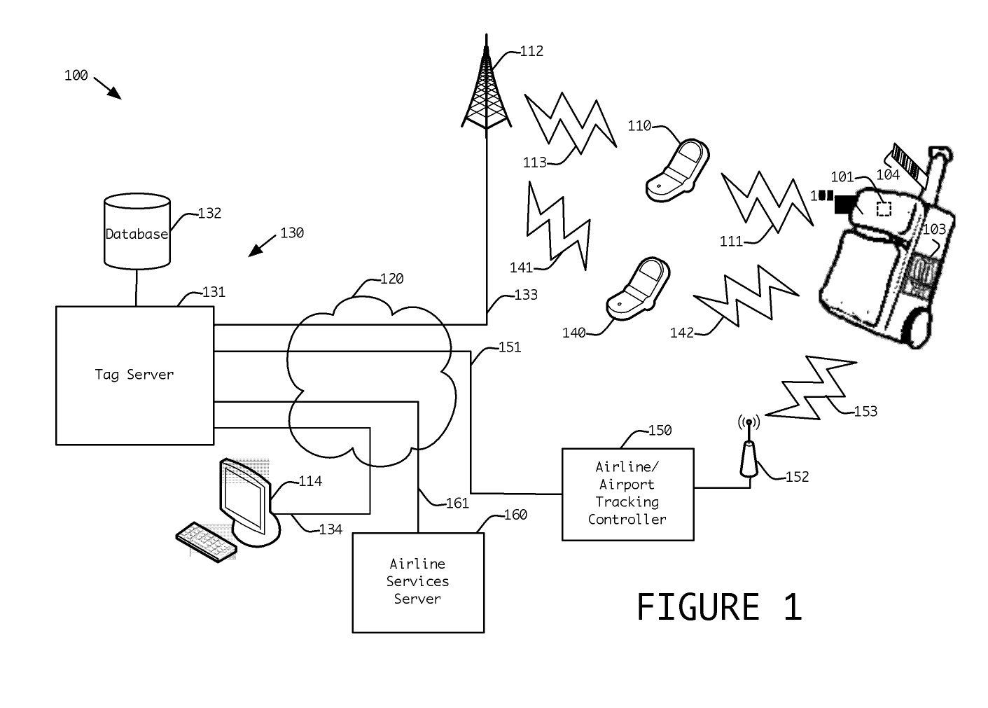

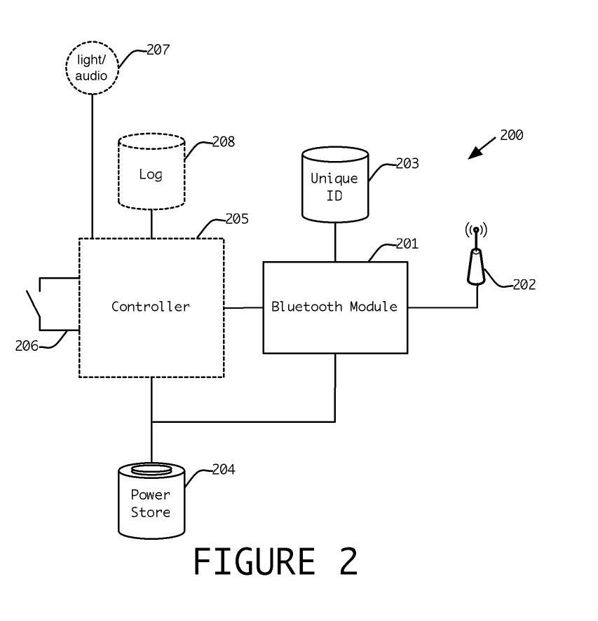

With respect to FIG. 1, baggage tracking and recovery system 100 works with bag 102 (a piece of baggage) having wireless electronic tag 101, which may be carried internal, or external (e.g., as a label) to bag 102. An example detailed embodiment of tag 101 is provided below in conjunction with FIG. 2. In some cases, an external graphic label 103 may be applied to bag 102 to indicate that it may contain tag 101.

Tag 101 can be detected by smartphone 110 through short-range wireless connections 111 if tag 101 is in proximity. Smartphone 110 belongs to the customer owning bag 102. The primary user of the system is this “customer” owning bag 102, though other users (airline employees, airport employees, and other customers) may play a role.

In some embodiments of the present invention, smartphone 110 is equipped with Bluetooth® technology for short-range wireless communication with tag 101. Bluetooth® is an example of a wireless communication technology suitable for use in the present invention. Bluetooth® enjoys widespread use in a variety of applications and is relatively low cost.

When the customer holding smartphone 110 is attempting to locate bag 102, an application (app.) in the smartphone 110 can attempt to contact tag 101 through wireless connection 111. If successful, the app. reports that bag 102 is in proximity, and may trigger tag 101 to flash or beep to better indicate the location of bag 102.

In some embodiments, tag 101 can be detected by smartphone 140 through short-range wireless connections 142 if tag 101 is in proximity, where smartphone 140 belongs to another customer or an airline or airport employee. Likewise, tracking controller 150, operated by an airline or an airport, has one or more antennae 152 able to detect tag 101 through wireless connection 153 if tag 101 is nearby.

For those embodiments where smartphone 140 or tracking controller 150 are able to help locate bag 102, smartphone 110 needs a wireless connection 113 to cellular network 112 (or a Wi-Fi network) to access connection 133 through the Internet 120 to tag manager 130. The application on smartphone 110 can request assistance in locating bag 102 through tag manager 130, which can relay this request to other devices such as smartphone 140 (through wireless connection 141), or tracking controller 150 (through connection 151). If either smartphone 140 or tracking controller 150 are successful in detecting tag 101, thereby locating bag 102, they can report their success to tag manager 130; the report in turn being relayed to smartphone 110.

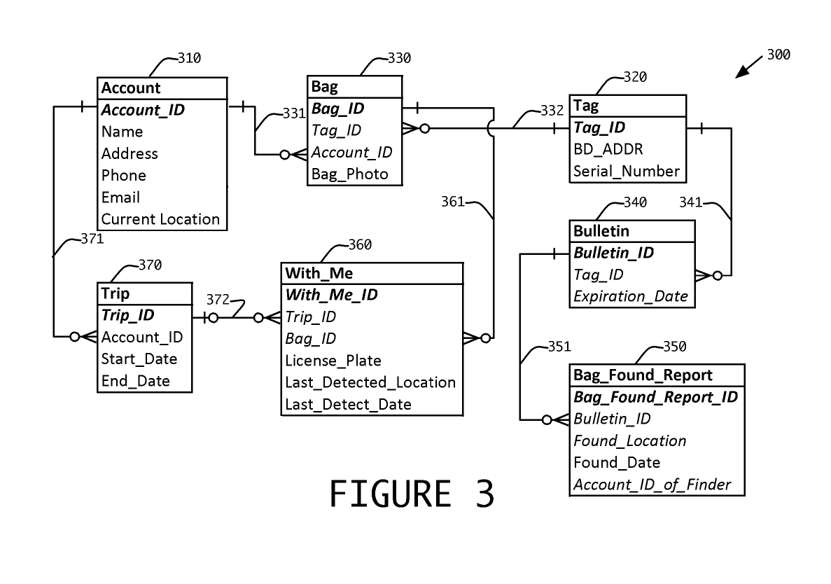

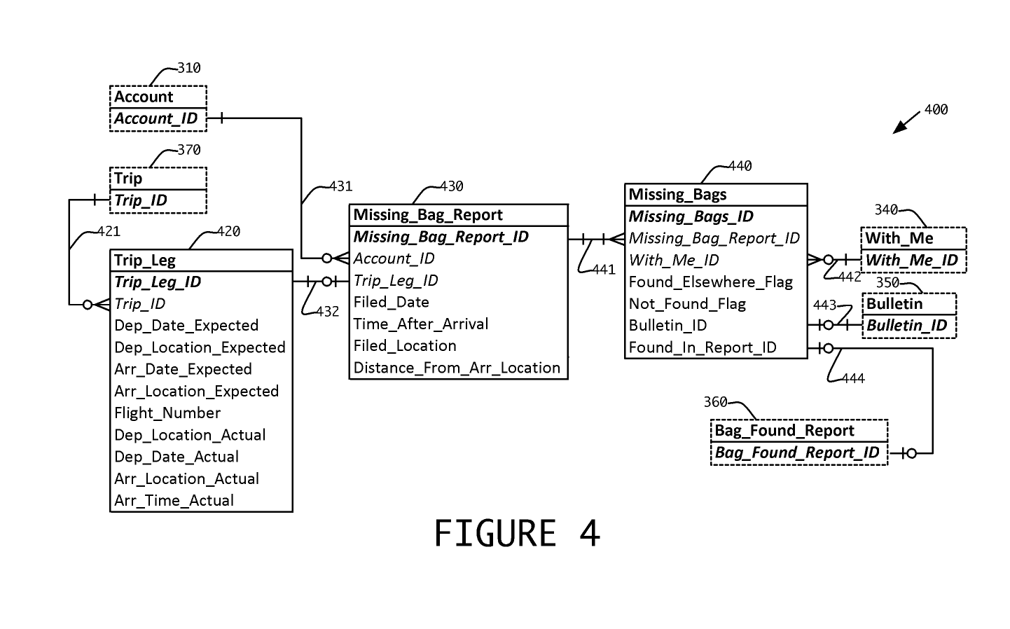

Tag manager 130 comprises tag server 131 and database 132, through which tag manager 130 is able to keep track of the association between bags such as 102, tags such as 101 and pending requests for assistance locating certain bags, and responses thereto. One example configuration of database 132 is discussed further below in conjunction with FIGS. 3 and 4.

In some embodiments, remote terminal 144, which may be a PC running a web browser, can communicate over connection 134 with tag manager 130, and be used for some transactions not requiring communication with tag 101 that would otherwise be conducted through the app. on smartphone 110.

If bag 102 cannot be found, or is found by another customer or airline/airport staff (e.g., with smartphone 140, or tracking controller 150, or other means), then a lost baggage report can be provided by tag manager 130 via connection 161 to an airline service server 160. This saves the customer, owning but not finding, bag 102 the delay and paperwork normally associated with registering claim for a lost bag with an airline.

Referring to FIG. 2, a particular embodiment of tag 101 is shown as Bluetooth® tag 200, comprising a Bluetooth® communication module 201 connected to antenna 202 for exchanging wireless communication with other devices such as smartphones 110, 140, and controller 150. A key element of tag 101, regardless of embodiment, is a unique ID 203 which can be used in communications sent to other devices 110, 140, 150, or recognized in communications received from them. Tag 200 also contains a power store 204, such as a battery, capacitor, power scavenging system, or the like. In some implementations of tag 200, a controller 205 is provided having a connection to communication module 201 to respond to certain communications, e.g., by activating a light or audio annunciator 207, or recording or reporting events in a log 208. In some embodiments, a button 206 can be used to activate tag 200, which would otherwise automatically deactivate after a predetermined amount of time (such as 72 hours or so) to conserve power in store 204.

FIG. 3 shows an embodiment of tag portion 300 of database 132 concerned with the association between tags such as 101, bags such as 102, and an account belonging to the owner of bag 102. In FIGS. 3 and 4, table titles are shown in bold; key fields are shown in bold italics; and foreign key fields are shown in non-bold italics. In FIG. 4, abbreviated tables from FIG. 3 are shown in dotted outlines with only the key fields listed. Relationships are shown in crow's foot notation with example restrictions shown (for example to suggest where a relationship may or may not be required, and where one or many associations might be allowed).

Each bag owner, such as the customer with smartphone 110, may have an account represented by a record in account table 310. Each such record can identify the corresponding owner; provide contact information; and in some embodiments, login credentials.

In this particular embodiment, each tag 101 sold, manufactured, or registered (depending upon policy) can be recorded in a unique record in tag table 320. The unique ID 203 of each tag can be noted in the corresponding record in table 320, which in this example is kept in the BD_ADDR field (the formal name for the unique device address in the well-known Bluetooth® communication protocol). Additionally, each tag may also be provided with a unique serial number, also recorded here, which may be printed on the outside of the tag 101 to allow human identification of tag 101 without requiring a wireless transaction.

A participating customer can associate bag 102 with his corresponding account record in account table 310 through the application on smartphone 110 (or, alternatively, through PC 114), where the application creates a record corresponding to bag 102 in bag table 330 having bag-account association 331. The addition to the bag record of bag-tag relationship 332 associates a tag 101 registered in tag table 320 and acquired by the bag owner. Additional data about the bag may also be added to the record in bag table 330, for example, a photograph of the bag, which may be used for identification purposes, or in later transactions, such as proving value, damage, and the like.

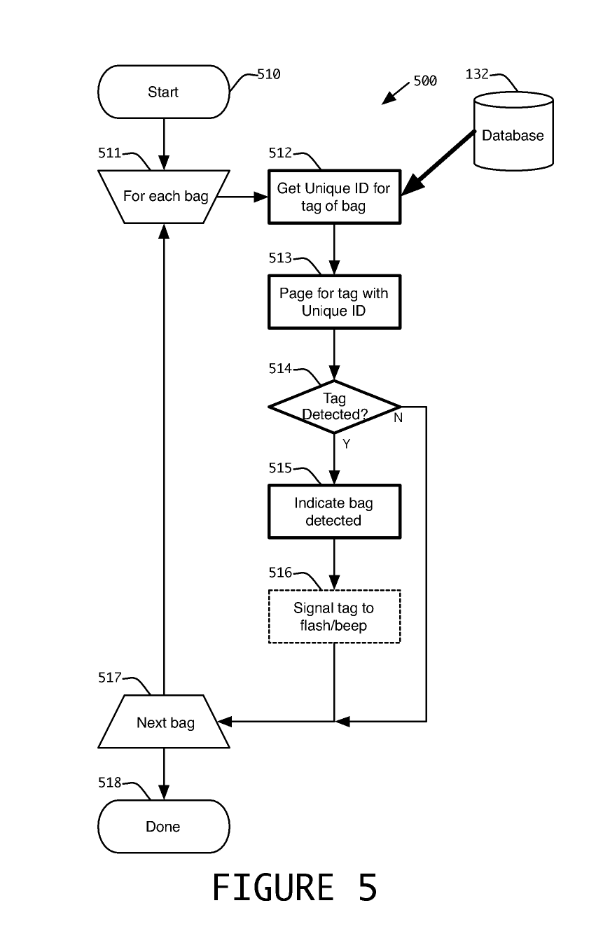

The three tables relating a customer's account information, to bags and their associated tags is sufficient to provide a transaction functionality as shown in an “Is My Bag Here?” transaction, discussed below in conjunction with FIG. 5. In some embodiments capable of this transaction, tag manager 130 is not needed, and only the records providing bag-tag association 332 are necessary which can be kept on smartphone 110 and are sufficient to keep track of which bag corresponds to which tag. In a particular minimal embodiment, tag table 320 is the only element listing the records of tags 101 belonging to the customer.

For cases where a customer owns many bags, but is actually traveling with fewer, it can be useful to note precisely which bags are of present concern. The with_me table 360 contains a record for each bag with which a customer is currently concerned, that is, which bags 102 are accompanying the CUSTOMER on a trip. The trip itself may be further described in trip table 370 where each record describes a single trip for the associated customer.

A particular example is as follows: As a customer is checking it at the airport counter, the customer closes switch 206 to activate each tag 101 and inserts it into bag 102. The application on smartphone 110 communicates to the newly powered up tag 101, and prompts for a photograph of the just-tagged bag. This communication between the smartphone 110 and tag 101 may also indicate the status of the battery 204 powering tag 101. The photograph may be stored in the corresponding bag record in bag table 330. The smartphone application may automatically recognize that the current location is at an airport, or it may be manually informed that a trip is starting. The application may prompt for start and end dates for the current trip which may be stored as a trip record in trip table 370. A “this bag is with me” record can be created for each bag 102 in with_me table 360. Thus, the with_me table forms a many-to-many relationship between bags and trips through relationships 361 and 372. The application may further prompt for a photograph or barcode scan of each bag's “license plate” (the airline industry term for the encrypted barcoded label 104 applied to each bag checked for use in subsequent routing to the current destination). The “license plate” information may be useful for subsequently filing a missing bag report or otherwise helping airport and airline personnel to identify bag 102 with their own, pre-existing systems.

If these records are to be supplied to tag manager 130 and stored in database 132, then they are further associated with the customer's account in account table 310 by relationships 331 and 371. This allows large numbers of customers and their corresponding bags, tags, and trips, to be unambiguously tracked by manager 130.

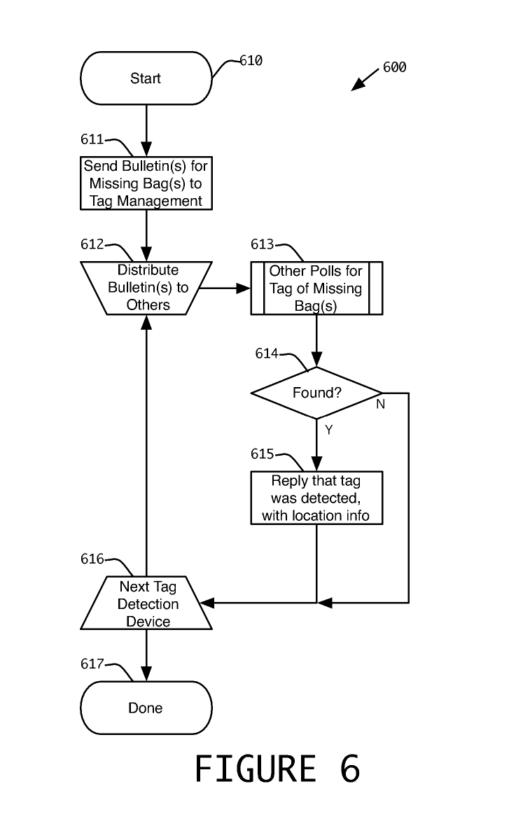

When other tag detection devices such as smartphone 140 or airline/airport tracking equipment 150 are to be enlisted in the search for bag 102 to provide a “Where Is My Bag?” transaction, as discussed below in conjunction with FIG. 6, then tag manager 130 is helpful for disseminating a request for assistance from the application on smartphone 110 to the other tag detection devices 140, 150. Such a request, a bulletin, may be recorded in bulletin table 340, and may be associated with the corresponding tag record through relationship 341. This provides a bulletin with access to the unique ID 203 (the BD_ADDR field) for tag 101. A bulletin may be qualified with an “expiration date”, after which any receiving tag detection devices can ignore or delete the bulletin. This can allow the bulletin to have effect only for a limited time, (for example, an hour). In other embodiments, a bulletin may be explicitly recalled or canceled rather than being provided with an expiration time. In still other embodiments, a bulletin may be further qualified by a location restriction such that only tag detection devices within a particular area need search for the bag. Whenever a tag is detected, a record of the location and time of the most recent detection may be recorded in the database as shown in the example tag portion 300, as fields in the with_me table 360.

In alternative example embodiments, bulletins can be associated with bag records in table 330 and obtain the unique ID of the corresponding tag through relationship 332 rather than directly through 341. It should be recognized that other such modifications to the data structure (or even the use of a different data structure paradigm rather than a relational database, as shown) are not departures from these teachings, but are modifications thereto, and are within the scope of the present invention.

Ultimately, when a “Where Is My Bag?” transaction results in the bag being located by any tag detection device 110, 140, 150, a record of the successful find can be generated and recorded in Bag_Found_Report table 350, noting, for instance, to which bulletin the report corresponds (forming relationship 351); where the tag/bag was detected; when; and if desired, the ID of the finder forming a relationship with a record in account table 310).

With these tables, 310, 320, 330, 340, 350, 360, 370, their equivalent, or in some embodiments less, a customer may search for a bag 102 through its tag 101 directly using smartphone 110 as a tag detection device, or by enlisting the assistance of other tag detection devices 140, 150, through tag manager 130. All or part of tag portion 300 of a database may be recorded in database 132 of tag manager 130 with copies of some records retained on smartphone 110. Updates to database 132 can generally occur in response to entries made by customers logged into their respective accounts through smartphones 110 or terminals 114. In some embodiments, records from tag portion 300 corresponding to a customer's account may be kept locally in that customer's smartphone 110, and the embodiment may eliminate tag service 130 altogether. In other embodiments, assistance may be sought from smartphone 140 or tracking controller 150 directly, without recourse to tag manager 130 (for example, where all the phones of a family traveling together are enlisted to poll for tag 101, or where communication with tracking controller 150 is provided to smartphone 110 in the baggage claim area of an airport).

FIG. 4, shows trip portion 400 of database 132, which extends the capabilities of tag portion 300. In this portion, a trip recorded in trip table 370 can be associated with multiple legs, each recorded in trip_leg table 420 and associated with the corresponding trip by relationship 421. The corresponding flight number, expected departure location and time, expected arrival location and time, and actual locations and times can characterize each leg. This information might be obtained, for example, by manual entry from the customer, or by retrieval from one or more airline services servers 160, for example by using a manually entered six-character alphanumeric confirmation number associated with the trip (and presently used throughout the airline industry), or by search after logging into one or more of the customer's accounts on airline servers 160, using login information (such as name and password) regarding his accounts on those servers stored in conjunction with his account record in table 310.

Regardless of how trip leg information is obtained, such information allows tag manager 130 to better anticipate where a bag might be at any given time, and reduces the number of locations needing to be searched when a particular bag is sought. For example, if two consecutive flights in a trip represent a short connection, i.e., the actual arrival time of the first flight is too close to the actual departure time of a the second flight, then a heuristic in tag manager 130 might consider that a bag 102 in a corresponding with_me record from table 360 is more likely to have missed the connection than when the connection time is larger. From that, the actual destination location of the first flight becomes a more likely place to search for bag 102 than it might be otherwise.

If a destination is the final leg in a trip, and the bags cannot be located within a reasonable time (perhaps determined by airline policy), or if the bags are located, but are not at the correct destination, then a missing bag report can be automatically filed with smartphone 110 and submitted to the airline services server 160 either directly, or through tag manager 130. The missing bag report may be stored as a record in table 430 and related to the customer's account (with relationship 431); the trip and/or trip leg (such as with relationship 432); and contain the date the report is being filed; a note as to how long after the final flight's actual arrival time the report is being filed; the location from where the report is being filed; and a note as to how far from the arrival airport this represents. This allows verification of airline policies, for example, that require the report to be filed at the arrival airport and not sooner than one hour after the flight has arrived unless the bags are known to be elsewhere. Associated with the report in table 430 through relationship 441 are individual records for each missing bag stored in missing_bags table 440. Relationship 442 to the corresponding with_me record provides access to the info from “license plate” 104 to a photograph of bag 102 (through additional relationship 361), and via 443 to a bulletin, or through 444 to a bag_found_report 360 citing either a bulletin resulting in no found reports, or a report that the bag is located other than at the actual destination. The ability to file missing bag reports electronically allows the baggage to leave the vicinity of the airport earlier and with less waiting in line than for filing present-day manual paper reports. Further, the information provided by database 132 and enforcement of airline policies concerning waiting an adequate amount of time at the airport, except when bags are known to be elsewhere, make better use of the customer's time and minimize the impact of an already inconvenient situation.

FIG. 5, shows a processes illustrating how the unique ID 203 such as stored in tag records in 320 are used, as bag proximity check (“Is My Bag Here?”). Process 500 determines whether or not a particular bag 102 is nearby a tag detection device such as one of smartphones 110, 140, or antenna 152 of airport/airline tracking controller 150. In some contexts, process 500 may be performed by smartphone 140 or controller 150 according to a remote request. In a minimal embodiment, smartphone 110 performs process 500.

At 510, smartphone 110 is activated, and the application for managing a customer's bags is operating and has just received a request to search for one or more bags. Process 500 may be manually triggered, for example by the customer pressing a graphical user interface (GUI) button on smartphone 110 to determine “Is My Bag Here?” Below, FIG. 6 shows that process 500 may be triggered in other tag detection devices (140, 150) by a remote request, for example when a customer presses a GUI button on smartphone 110 to determine “Where Is My Bag?” resulting in tag manager 130 inducing other tag detectors (140, 150) to conduct bag proximity check process 500 by sending them a corresponding bulletin, and consolidating their results (if any).

At 511, a loop begins, testing for each bag sought. When conducted by smartphone 110, these are the bags in with_me table 360 for the customer's current trip, or in a different embodiment, any of the bags in table 330. At 512, the unique ID 203 is provided, for example from database 132, from the tag records having association 332 with sought bags. In some embodiments, the unique ID 203 may already be provided or known.

At 513, the tag detection device (smartphone 110, 140, 150) pages for tag 101. In one embodiment, the page may include unique ID 203, in which case only tag 101 might reply if nearby, in which case tag 101 is detected and bag 102 located.

In other embodiments, at 513, the page may include none of unique ID 203, or only a portion thereof, in which case, zero, one, or more tags may reply with their unique ID. If a reply is received, the unique ID returned may be compared to the one expected, and if it matches, the tag 101 has been detected and the bag 102 located.

At 514, if the tag 101 has been detected, then at 515 an indication is given that the tag 101 (or bag 102) has been located. If manually initiated by the customer on smartphone 110, this indication would be given through the GUI. Otherwise, this indication would be returned to tag manager 130 as a bag_found report corresponding to the bulletin that initiated this instance of bag proximity check 500, for storage in table 350.

At 516, according to capability, preference, or policy, a detected tag 101 may activate lights or audio annunciator 207 to facilitate locating bag 102. For example, bag 102 being found by the customer's own smartphone 110 may induce the annunciation, or an airport or airline employee is using smartphone 140 may induce it. But when automatic tracking controller 150, or another customer carrying smartphone 140 makes the find, the tag may omit the annunciation step 516.

After detection of bag 101 has been noted at 515, or if at 514, tag 101 was not detected, then at 517, the loop continues looking for other requested bags, until all have been tried, in which case the loop terminates at 518.

In some embodiments, the loop from 511 to 517 may be repeat for as-yet-unfound bags for a predetermined amount of time (for example, 10 minutes), or until a bulletin expires, or until the appropriate location has been left (such as if smartphone 140 leaves the area of the airport).

FIG. 6 shows one embodiment of the “Where Is My Bag?” bag search process 600 initiated at 610 by a customer on smartphone 110 interacting with a GUI, or by an airport/airline employee using smartphone 140, or through terminal 114, or by an automated process from airline services server 160. This results at 611 in one or more search requests for bags being sent such as in the form of bulletins, to tag manager 130.

At 612, tag manager 130 distributes the bulletin(s) and the corresponding unique ID information to tag detection devices (e.g., 110, 140, 150) that may be in proximity to the bag sought. In a particular embodiment, the bulletin may be sent to all tag detection devices, but a more efficient approach may limit the bulletins to only those locations where the bag may feasibly be found, or better, where the bag may likely be found.

At 613, a receiving tag detection device (e.g., smartphone 140) performs a bag proximity check, for example using process 500. If at 614, the bag 102 has been found, (the tag 101 has been detected), then at 615, a reply is returned to tag manager 130, for example as a bag found report suitable for storage in table 350 citing the corresponding bulletin, current location, and possibly the account ID of the owner of the finder detection device.

At 613, in the case of airline/airport tracking controller 150, there may also be available information obtained from scanners able to detect “license plate” label 104 which would be reacted to in the same manner as if tag 101 had been detected through antenna 152.

If, ultimately, the tag detection device does not detect tag 101, then at 614 the process ceases work on the corresponding bulletin, for example based on the various timing and location termination criteria discussed above for process 500.

At 616, tag manager 130 continues to wait for responses from other tag detection devices until at 617 either a detection of tag 101 has been reported, or due to all the timeouts having been reached, the process 600 ends.

Process 600 may also be initiated automatically, as (or even before) a customer's plane arrives. If tag manager 130 determines heuristically that there are any locations other than the current destination airport where a bag is sufficiently likely to be located (say because the customer's check-in was late, or because a connection between flights was shorter than appropriate), then system 100 may search for customer's bags in those other locations. Similarly, if the customer's bags are likely to have arrived in advance of the customer's own flight (say because the customer checked-in far in advance of his flight and his bags may have traveled on an earlier plane), then a search including the destination airport may be conducted in advance of his arrival. In this way, smartphone 110 may be able to alert the customer that bag 102 has already arrived and is available for immediate pickup, or that bag 102 has missed this flight and there will be a substantial delay in retrieving it (or that he may immediately file a missing bag report). In any of these cases, there is no need for the customer to spend unnecessary time looking in the wrong place for bag 102, or hoping for a bag to arrive that isn't available.

The pseudocode loop from 612 to 616 may be implemented in a large number of ways. The bulletin may be distributed to selected detection devices (whether all, or preferably “likely”) substantially at once, or it may be distributed gradually, initially to the most likely and proceeding to the less likely. This may be done, for example, according to heuristics driven by trip leg information from table 420 and/or from information about the permanent location of tag detection device 150 or current location information about tag detection devices 110, 140 (from the current location field in account table 310, periodically updated by the application in smartphones 110, 140). The result is that many tag detection devices may be simultaneously attempting to detect tag 101, and many other tags that are the subject of current bulletins and manual initiations of process 500.

In some embodiments of process 600, tag manager 131 may query airline services server 160 identifying bag 102 with “license plate” label 104 if bag tracking with such labels is available. The response to such a query can be interpreted by tag server 130 and included in the status of bag 102, for example as a bag found report in table 350, or in some other representation.

Thus, there may be many instances of processes 500 and 600 operating simultaneously. There are also many possible embodiments of the present invention, ranging from the simple, “Is My Bag Here?” check (process 500) to the distributed implementation of the “Where Is My Bag?” query (process 600).

Thus, a list of transactions that may be provided to the customer through smartphone 110 include:

a) associating a bag 102 with a tag 101;
b) adding or updating information about a bag (its picture or that of its current “license plate”);
c) detecting whether bag 102 is nearby using process 500;
d) providing details associated with a particular trip (or access thereto);
e) associating a bag with a particular trip;
f) confirming battery status of tag 101;
g) creating or updating an account on tag manager 130;
h) searching for bag 102 using process 600;
i) reporting the current status of a bag (present at destination, not present at destination); and,
j) filing a missing bag report with an airline.

Some of these transactions (a, b, d, e, g, h, i, j) may be conveniently performed with terminal 114; some (c, h, i) may be initiated by the airline or airport personnel, for example, through smartphone 140 or terminal 114; and some (h, i) may be initiated automatically, for example, by tag manager 130.

While this description of the present invention has used the term Bluetooth® to describe a short-range wireless communication system, any wireless service may be used in place of the particular radio service described by the Bluetooth® standard. Any wireless communications technique is within the scope of the present invention.

While this description has referred to a cellular telephone, cellphone or smartphone, any portable electronic device may be used and is within the scope of the present invention.

Several descriptions and illustrations have been provided to aid in understanding the present invention. One with skill in the art will realize that numerous changes and variations may be made without departing from the spirit of the invention. Each of these changes and variations is within the scope of the present invention.

We claim:

1. A method of tracking baggage comprising:
registering a user by gathering ID information;
providing said user with an electronic baggage tag that can be placed in a piece of baggage, said electronic baggage tag associated with said ID information;
allowing a plurality of cellular telephones adapted to communicate with said electronic baggage tag to simultaneously wirelessly search for said electronic baggage tag if the piece of baggage is lost;
notifying said user when the piece of baggage is found.

2. The method of claim 1 wherein said search is conducted using BLUETOOTH™ communication.

3. A system adapted to find lost baggage at airports comprising:
a server, said server adapted to gather ID information from customers;
at least one RF-enabled tag, said tag adapted to be placed in a piece of luggage;
a plurality of identical applications executing on a plurality of cellular telephones belonging to said customers, said applications adapted to cause said plurality of cellular telephones to attempt to establish RF communication with said RF-enabled tag if said piece of luggage is reported lost to said server;
said applications also adapted to report successfully establishing RF communication with said RF-enabled tag to said server.

4. The system of claim 3 wherein said RF-enabled tag communicates using BLUETOOTH™ communication.
